(19) United States
(12) Patent Application Publication
(10) Pub. No.: US 2021/0173527 A1
(43) Pub. Date: Jun. 10, 2021

(54) ELECTRONIC APPARATUS EXECUTING PROCESSING BASED ON MOVE OPERATION

(71) Applicant: CANON KABUSHIKI KAISHA, Tokyo (JP)

(72) Inventor: Yohei Sato, Kanagawa (JP)

(21) Appl. No.: 17/110,472

(22) Filed: Dec. 3, 2020

(30) Foreign Application Priority Data
Dec. 5, 2019 (JP) 2019-220335

(51) Int. Cl. G06F 3/044; H04N 5/232; G06F 3/0488

(52) U.S. Cl. CPC G06F 3/0446; G06F 3/04886; G06F 3/04883; H04N 5/232935

(57) ABSTRACT

An electronic apparatus includes: an operation-detecting unit configured to detect a move operation; a notification unit configured to send a notification prompting a user to perform a move operation of drawing a linear trajectory in a specific direction; and an execution unit configured to (1) acquire reference curve information indicating information on a curve based on a trajectory of a first move operation corresponding to the notification, which has been detected by the operation-detecting unit, wherein the reference curve information is information for determining whether the move operation is in the specific direction, and (2) execute processing based on a direction based on comparison between the reference curve information and a trajectory of a third move operation, in a case where the third move operation is performed later than the first move operation.

### BACKGROUND OF THE INVENTION

### Field of the Invention

The present invention relates to an electronic apparatus having a function of detecting a move operation, and particularly, relates to a calibration method of the function.

### Description of the Related Art

An electronic apparatus on which various operating members (pointing devices) for designating positions are mounted is known. For example, an electronic apparatus in which selection or movement of an object is controlled according to a move operation (a slide operation) of touching and sliding a touch operating member is known as an electronic apparatus having a touch operating member which is one kind of a pointing device. An electronic apparatus in which selection or movement of an object is controlled by a mouse drag or the like is also known.

Japanese Patent Application Publication No. 2018-128738 proposes a method of selecting a position based on movement of a position to be touched subsequently from among a plurality of selection candidate positions located in a moving direction obtained by two points of an initial slide operation so that a position located in a direction intended by a user can be easily selected by the slide operation.

In a move operation of moving an operating body (a finger or the like touching a touch operating member) or an operating member (a mouse or the like), the habit of moving a moving target generally differs from user to user. Due to factors such as a difference in the habit of each user, the direction of a move operation intended by a user may differ from an operating direction detected by the device, and a move operation in the direction intended by the user may not be performed. In the method disclosed in Japanese Patent Application Publication No. 2018-128738, since a subsequent moving direction (an operating direction) is limited by the two points of an initial slide operation, in a case where the user changes the moving direction intentionally during the slide operation, the position located in the direction intended by the user may not be selected.

### SUMMARY OF THE INVENTION

Therefore, the present invention provides an electronic apparatus in which processing corresponding to a direction closer to a direction intended by a user is executed as processing that corresponds to the direction of a move operation.

The present invention in its first aspect provides an electronic apparatus includes: at least one processor and/or at least one circuit to perform the operations of the following units: an operation-detecting unit configured to detect a move operation; a notification unit configured to send a notification prompting a user to perform a move operation of drawing a linear trajectory in a specific direction; and an execution unit configured to (1) acquire reference curve information indicating information on a curve based on a trajectory of a first move operation corresponding to the notification, which has been detected by the operation-detecting unit, wherein the reference curve information is information for determining whether the move operation is in the specific direction, and (2) execute processing based on a direction based on comparison between the reference curve information and a trajectory of a third move operation, in a case where the third move operation is performed later than the first move operation.

Further features of the present invention will become apparent from the following description of exemplary embodiments with reference to the attached drawings.

### BRIEF DESCRIPTION OF THE DRAWINGS

FIGS. 1A and 1B are external views of a camera;

FIG. 2 is a block diagram illustrating a configuration example of a camera;

FIGS. 3A and 3B are diagrams illustrating the structure of an AF-ON button; and

FIGS. 4A and 4B are diagrams illustrating an operation example of a camera.

FIG. 5 is a flowchart of a first calibration process:

FIG. 6 is a diagram illustrating an example of an operation instruction screen:

FIGS. 7A and 7B are diagrams illustrating a specific example of the first calibration process:

FIG. 8 is a flowchart of a first slide response process;

FIGS. 9A to 9F are diagrams illustrating a specific example of the first slide response process;

FIG. 10 is a flowchart of a second slide response process:

FIGS. 11A and 11B are diagrams illustrating a specific example of the second slide response process:

FIG. 12 is a flowchart of the second slide response process; and

FIGS. 13A to 13F are diagrams illustrating a specific example of the second slide response process.

### DESCRIPTION OF THE EMBODIMENTS

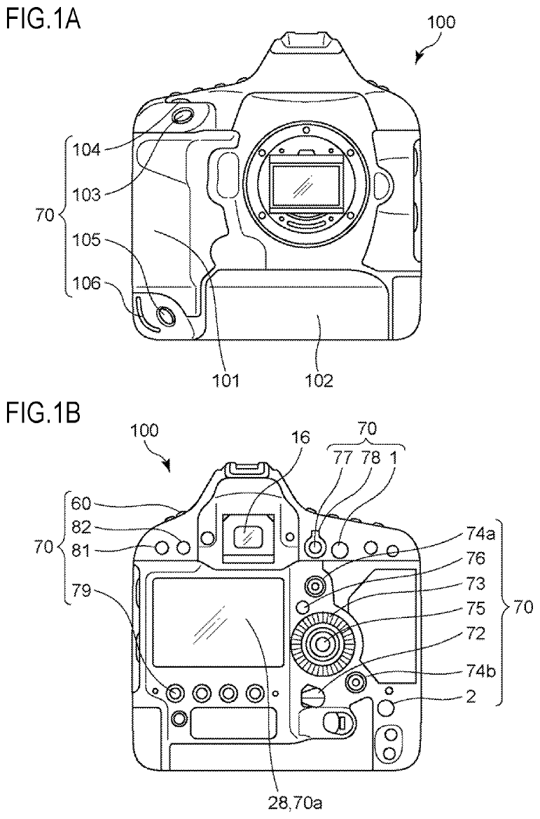

Hereinafter, preferred embodiments of the present invention will be described in detail with reference to the accompanying drawings. FIGS. 1A and 1B are external views of the body of a single-lens reflex camera 100 (hereinafter referred to as a camera) as an example of an imaging apparatus to which the present invention can be applied. Specifically. FIG. 1A is a view of the camera 100 as seen from a first surface (front surface) side and illustrates a state where a photographing lens unit is removed. FIG. 1B is a view of the camera 100 as seen from a second surface (back surface) side. The first surface is a front surface of the camera, which is a subject-side surface (the surface on the imaging direction side). The second surface is a back surface of the camera, which is a surface on the back side (opposite side) of the first surface, and is the surface close to the photographer looking into a finder 16.

As illustrated in FIG. 1A, the camera 100 is provided with a first grip portion 101 that protrudes forward so that a user who uses the camera 100 can stably grip and operate the camera 100 in a horizontal capturing mode. Moreover, the camera 100 is provided with a second grip portion 102 that protrudes forward so that a user who uses the camera 100 can stably grip and operate the camera 100 in a vertical capturing mode. The first grip portion 101 extends along a first side (the left side among the two vertical sides on the left and right sides of FIG. 1A) of the front surface of the camera 100, and the second grip portion 102 extends along a second side (the lower side among the two horizontal sides on the upper and lower sides of FIG. 1A) adjacent to the first side of the front surface. Shutter buttons 103 and 105 are operating members for issuing a photographing instruction. Main electronic dials 104 and 106 are rotary operating members and setting values such as a shutter speed and an aperture can be changed by rotating the main electronic dials 104 and 106. The shutter buttons 103 and 105 and the main electronic dials 104 and 106 are included in an operating unit 70. The shutter button 103 and the main electronic dial 104 are mainly used in a horizontal capturing mode and the shutter button 105 and the main electronic dial 106 are mainly used in a vertical capturing mode.

In FIG. 1B, a display unit 28 displays images and various pieces of information. The display unit 28 is provided to be superimposed on or integrated with a touch panel 70a that can accept a touch operation (can detect a touch). AF-ON buttons 1 and 2 are operating members for setting a focus adjustment position and starting AF and are included in the operating unit 70. In the present embodiment, the AF-ON buttons 1 and 2 are touch operating members (infrared sensors in the present embodiment) that can accept a touch operation and a push operation. Such an optical operating member will be referred to as an optical tracking pointer (OTP). A user can perform a touch operation and a slide operation in an arbitrary two-dimensional direction with the thumb of the right hand holding the first grip portion 101 with respect to the AF-ON button 1 while looking into the finder 16 in a horizontal mode (in a state of holding the camera 100 in the horizontal position). Moreover, the user can perform a touch operation and a slide operation in an arbitrary two-dimensional direction with the thumb of the right hand holding the second grip portion 102 with respect to the AF-ON button 2 while looking at the finder 16 in a vertical mode. The vertical mode is a state of holding the camera 100 at a vertical position shifted by 90° from the horizontal position. The user operating the camera 100 can move a range-finding frame (the position of an AF frame used for AF, a focus adjustment position, and a focus detection position) displayed on the display unit 28 by a slide operation on the AF-ON button 1 or 2. Moreover, the user can immediately start AF based on the position of the range-finding frame by a push operation on the AF-ON button 1 or 2. The AF-ON button 1 is mainly used in a horizontal capturing mode and the AF-ON button 2 is mainly used in a vertical capturing mode.

The arrangement of the AF-ON buttons 1 and 2 will be described. As illustrated in FIG. 1B, the AF-ON buttons 1 and 2 are disposed on the back surface of the camera 100. The AF-ON button 2 is disposed at a position closer to an apex formed by the side (the first side) extending along the first grip portion 101 and the side (the second side) extending along the second grip portion 102 than the other apexes on the back surface of the camera 100. Moreover, the AF-ON button 2 is disposed at a position closer to the apex formed by the side along the first grip portion 101 and the side along the second grip portion 102 than the AF-ON button 1. The side (the first side) along the first grip portion 101 on the back surface of the camera 100 is the right side among the two vertical sides on the left and right sides of FIG. 1B. The side (the second side) along the second grip portion 102 on the back surface of the camera 100 is the lower side among the two horizontal sides on the upper and lower sides of FIG. 1B. Here, the above-mentioned apex is an apex (an imaginary apex) of a polygon when the back surface of the camera 100 is regarded as a polygon. If the back surface of the camera 100 is a perfect polygon, the above-mentioned apex may be an apex (an actual apex of the camera 100) of the polygon. The first side is a right side (a vertical side) in the left-right direction of FIG. 1B, the second side is a lower side (a horizontal side) in the up-down direction of FIG. 1B, and the above-mentioned apex formed by the first and second sides is a bottom-right apex in FIG. 1B. The AF-ON button 2 is disposed at a position closer to an end (a lower end) on the opposite side of an end (that is, an upper end) on the side where the AF-ON button 1 is present, on the side (the first side) along the first grip portion 101. Moreover, the shutter button 103 is disposed at a position at which the shutter button 103 can be operated (pressed) by the index finger of the right hand holding the first grip portion 101, and the shutter button 105 is disposed at a position at which the shutter button 105 can be operated by the index finger of the right hand holding the second grip portion 102. The AF-ON button 1 is disposed at a position closer to the shutter button 103 than the AF-ON button 2, and the AF-ON button 2 is disposed at a position closer to the shutter button 105 than the AF-ON button 1.

The AF-ON buttons 1 and 2 are operating members different from the touch panel 70a and do not have a display function. In an example described later, an example of moving an indicator (an AF frame) indicating a range-finding position selected by an operation on the AF-ON buttons 1 and 2 is described. However, the function executed according to an operation on the AF-ON buttons 1 and 2 is not particularly limited. For example, an arbitrary indicator that is moved by a slide operation on the AF-ON buttons 1 and 2 may be used as long as the indicator is displayed on the display unit 28 and can be moved. For example, the indicator may be a pointing cursor such as a mouse cursor and may be a cursor indicating an option selected among a plurality of options (a plurality of items displayed on a menu screen). An indicator moved by a slide operation on the AF-ON button 1 may be different from an indicator moved by a slide operation on the AF-ON button 2. The function executed by a push operation on the AF-ON buttons 1 and 2 may be another function related to the function executed by the slide operation on the AF-ON buttons 1 and 2.

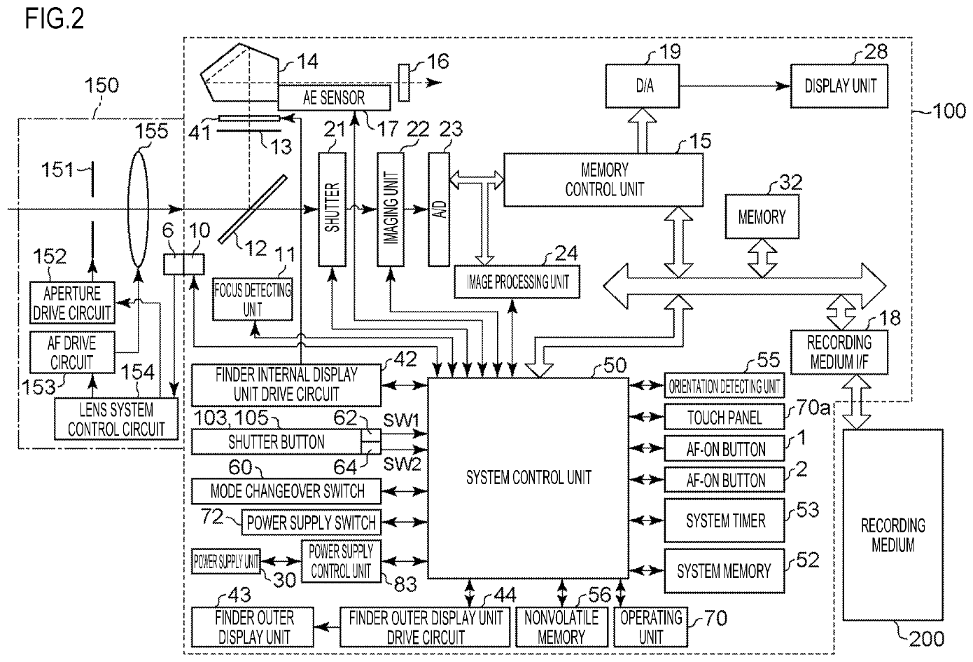

A mode changeover switch 60 is an operating member for switching various modes. A power supply switch 72 is an operating member for switching the power of the camera 100 on and off. A sub-electronic dial 73 is a rotary operating member for moving a selection frame and feeding images. Eight-direction keys 74a and 74b are operating members that can be pressed down in the up, down, left, right, upper left, lower left, upper right, and lower right directions, respectively, and processes corresponding to the directions in which the eight-direction keys 74a and 74b are pressed down can be performed. The eight-direction key 74a is mainly used in a horizontal capturing mode and the eight-direction key 74b is mainly used in a vertical capturing mode. A SET button 75 is an operating member mainly used for confirming a selection item. A still image/video selection switch 77 is an operating member for switching between a still image capturing mode and a video capturing mode. An LV button 78 is an operating member for switching a live-view (hereinafter, LV) on and off. When LV is on, a mirror 12 described later moves (mirror-up) to a retraction position retracted from an optical axis, subject light is guided to an imaging unit 22 described later, and an LV mode in which a LV image is captured is set. In the LV mode, a subject image can be viewed in the LV image. When the LV is off, the mirror 12 moves (mirror-down) onto the optical axis, subject light is reflected, the subject light is guided to the finder 16, and an OVF mode in which an optical image (an optical subject image) of the subject can be visually recognized from the finder 16 is set. A playback button 79 is an operating member for switching between a capturing mode (a photographing screen) and a playback mode (a playback screen). When a user presses the playback button 79 during a capturing mode, the user can enter a playback mode, and the latest image among the images recorded on a recording medium 200 (described later in FIG. 2) can be displayed on the display unit 28. A Q button 76 is an operating member for making quick setting. When a user presses the Q button 76 in a photographing screen, a setting item being displayed as a list of setting values can be selected. When a user selects a setting item, the user can enter a setting screen of each setting item. The mode changeover switch 60, the power supply switch 72, the sub-electronic dial 73, the eight-direction keys 74a and 74b, the SET button 75, the Q button 76, the still image/video selection switch 77, the LV button 78, and the playback button 79 are included in the operating unit 70. A menu button 81 is included in the operating unit 70 and is an operating member for making various settings of the camera 100. When the menu button 81 is pressed, a menu screen on which various settings can be made is displayed on the display unit 28. A user can make various settings immediately using the menu screen displayed on the display unit 28 and the sub-electronic dial 73, the eight-direction keys 74a and 74b, the SET button 75, and the main electronic dials 104 and 106. The finder 16 is a look-in-type (eyepiece) finder for confirming focus and composition of an optical image of a subject obtained through a lens unit. An INFO button 82 is included in the operating unit 70 and displays various pieces of information of the camera 100 on the display unit 28.

FIG. 2 is a block diagram illustrating a configuration example of the camera 100.

A lens unit 150 is a lens unit on which exchangeable photographing lenses are mounted. A lens 155 generally includes a plurality of lenses such as a focus lens group and a zoom lens group, but only one lens is illustrated in FIG. 2 for simplicity. A communication terminal 6 is a communication terminal for allowing the lens unit 150 to communicate with the camera 10, and a communication terminal 10 is a communication terminal for allowing the camera 100 to communicate with the lens unit 150. The lens unit 150 communicates with a system control unit 50 via the communication terminals 6 and 10. In the lens unit 150, an internal lens system control circuit 154 controls an aperture 151 with the aid of an aperture driving circuit 152 and displaces the position of the lens 155 with the aid of an AF drive circuit 153 to adjust the focus. The lens unit 150 is attached to a body side where the display unit 28 is present via an attachment portion to which the lens unit 150 can be attached. Various types of lenses such as a single-focus lens or a zoom lens can be attached as the lens unit 150.

An AE sensor 17 measures the luminance of a subject (a subject light) having passed through the lens unit 150 and the quick-return mirror 12 and formed on a focusing screen 13.

A focus detecting unit 11 is a phase difference detection-type AF sensor that captures an image (a subject light) incident through the quick-return mirror 12 and outputs defocus amount information to the system control unit 50. The system control unit 50 controls the lens unit 150 on the basis of the defocus amount information and performs phase difference AF. The AF method may not be phase difference AF but may be contrast AF. Moreover, the phase difference AF may not use the focus detecting unit 11 but may be performed on the basis of a defocus amount detected on an imaging plane of the imaging unit 22 (imaging plane phase difference AF).

The quick-return mirror 12 (hereinafter, a mirror 12) is moved up and down by an actuator (not illustrated) according to an instruction from the system control unit 50 during exposure, live-view photographing, and moving-image photographing. The mirror 12 is a mirror for switching a light flux incident from the lens 155 toward the finder 16 or the imaging unit 22. The mirror 12 is usually disposed so as to guide (reflect) a light flux toward the finder 16 (mirror-down). In a capturing mode or a live-view mode, the mirror 12 pops up to retract from a light flux so as to guide a light flux toward the imaging unit 22 (mirror-up). Moreover, a central part of the mirror 12 is configured as a half-mirror so that a portion of light can pass through the mirror 12, and the mirror 12 transmits a portion of a light flux so as to be incident on the focus detecting unit 11 for detecting the focus.

A user can confirm the focusing state and the composition of an optical image of a subject obtained through the lens unit 150 by observing an image formed on the focusing screen 13 through a pentaprism 14 and the finder 16.

A focal plane shutter 21 (shutter 21) controls an exposure time of the imaging unit 22 under the control of the system control unit 50.

The imaging unit 22 is an imaging device (an imaging sensor) composed of CCD or CMOS devices that convert an optical image to an electrical signal. An A/D converter 23 is used for converting an analog signal output from the imaging unit 22 to a digital signal.

An image processing unit 24 performs predetermined processing (pixel interpolation, resizing processing such as reduction, and color conversion processing) with respect to data from the A/D converter 23 or data from a memory control unit 15. The image processing unit 24 performs predetermined calculation processing using captured image data, and the system control unit 50 performs exposure control and ranging control on the basis of the obtained calculation results. In this way, TTL (through the lens)-type AF (auto focus) processing, AE (auto exposure) processing, and EF (flash free emission) processing are performed. The image processing unit 24 also performs predetermined calculation processing using captured image data and performs TTL-type AWB (auto white balance) processing on the basis of the obtained calculation results.

A memory 32 stores image data obtained by the imaging unit 22 and converted to digital data by the A/D converter 23 and image data for displaying on the display unit 28. The memory 32 has a storage capacity sufficient for storing a predetermined number of still images and a predetermined period of videos and audio. The memory 32 may be a removable recording medium such as a memory card and may be an internal memory.

The display unit 28 is a backside monitor for displaying an image, which is provided on the back surface of the camera 100 as illustrated in FIG. 1B. A D/A converter 19 converts image display data stored in the memory 32 to an analog signal and supplies the analog signal to the display unit 28. The display unit 28 may be a liquid-crystal display and may be another type of display such as an organic EL display as long as it displays an image.

An in-finder display portion 41 displays a frame (an AF frame) indicating a range-finding point being auto-focused presently and an icon indicating the setting state of the camera with the aid of an finder internal display unit drive circuit 42. A finder outer display unit 43 displays various setting values of the camera 100 such as a shutter speed and an aperture with the aid of a finder outer display unit drive circuit 44.

An orientation detecting unit 55 is a sensor for detecting an attitude according to the angle of the camera 100. On the basis of the attitude detected by the orientation detecting unit 55, it is possible to determine whether the image captured by the imaging unit 22 is an image captured with the camera 100 held horizontally or vertically. The system control unit 50 can add orientation information corresponding to the attitude detected by the orientation detecting unit 55 to an image file of the image captured by the imaging unit 22 and rotate and record the image. An acceleration sensor, a gyro sensor, or the like can be used as the orientation detecting unit 55. Using an acceleration sensor and a gyro sensor which is the orientation detecting unit 55, it is also possible to detect the movement (panning, tilting, lifting, and whether it is stationary) of the camera 100.

A nonvolatile memory 56 is a memory that is electrically erasable and rewritable by the system control unit 50, and an EEPROM, for example, is used. The nonvolatile memory 56 stores constants for operation of the system control unit 50, programs, and the like. The programs mentioned herein are programs for executing various flowcharts described later in the present embodiment.

The system control unit 50 includes at least one processor (including circuits) and controls the entire camera 100. The system control unit 50 realizes respective steps of processing of the present embodiment by executing the programs recorded on the nonvolatile memory 56. A system memory 52 loads constants for operation of the system control unit 50, variables, programs and the like read from the nonvolatile memory 56. Moreover, the system control unit 50 performs display control by controlling the memory 32, the D/A converter 19, the display unit 28, and the like.

A system timer 53 is a time measuring unit that measures the time used for various controls and the time of a built-in clock. The mode changeover switch 60 switches an operation mode of the system control unit 50 to a still image capturing mode or a video capturing mode. The still image capturing mode includes a P-mode (program AE), an M-mode (manual), and the like. Alternatively, after switching to a menu screen once with the mode changeover switch 60, the mode may be switched to any one of these modes included in the menu screen using another operating member. Similarly, the video capturing mode may include a plurality of modes. In the M-mode, a user can set an aperture value, a shutter speed, an ISO service and can perform photographing with exposure intended by the user.

A first shutter switch 62 is turned on by so-called half-pressing (photographing preparation instruction) in the middle of operation of the shutter buttons 103 and 105 provided in the camera 100 and generates a first shutter switch signal SW1. The system control unit 50 starts operations such as AF (autofocus) processing, AE (auto exposure) processing, AWB (auto white balance) processing, EF (flicker free emission) processing, and the like according to the first shutter switch signal SW1. Luminance is also measured by the AE sensor 17.

A second shutter switch 64 is turned on by full-pressing (photographing instruction) upon completion of operation of the shutter buttons 103 and 105 and generates a second shutter switch signal SW2. The system control unit 50 starts operations of a series of photographing processing from reading of signals from the imaging unit 22 to recording of images in the recording medium 200 as image files according to the second shutter switch signal SW2.

A power supply control unit 83 includes a battery detection circuit, a DC-DC converter, a switch circuit for switching blocks to be energized, and the like and detects attachment of a battery, the type of a battery, and a remaining battery level. Moreover, the power supply control unit 83 controls the DC-DC converter on the basis of the detection results and the instruction from the system control unit 50 and supplies a necessary voltage to each unit including the recording medium 200 for a necessary period. The power supply switch 72 is a switch for switching the power of the camera 100 on and off.

A power supply unit 30 includes a primary battery such as an alkaline battery or a lithium battery, a secondary battery such as a NiCd battery, a NiMH battery, or a Li battery, an AC adapter, and the like. A recording medium I/F 18 is an interface to the recording medium 200 such as a memory card or a hard disk. The recording medium 200 is a recording medium such as a memory card for recording captured images and is composed of a semiconductor memory, a magnetic disk, or the like.

As described above, the camera 100 has the touch panel 70a capable of detecting a touch on the display unit 28 (the touch panel 70a) as one kind of the operating unit 70. The touch panel 70a and the display unit 28 may be configured integrally. For example, the touch panel 70a has light transmittance such that the display of the display unit 28 is not disturbed and is attached to an upper layer of the display surface of the display unit 28. The input coordinates on the touch panel 70a are correlated with the display coordinates on the display unit 28. In this way, it is possible to configure a GUI (graphical user interface) as if a user can directly operate the screen displayed on the display unit 28. The system control unit 50 can detect the following touch operations or states on the touch panel 70a.
A finger or a pen which is not in touch with the touch panel 70a newly touches the touch panel 70a, that is the start of a touch (hereinafter referred to as a “touch-down”).
A state in which a finger or a pen is in touch with the touch panel 70a (hereinafter referred to as a “touch-on”).
A finger or a pen moves while touching the touch panel 70a (hereinafter referred to as a “touch-move”).
A finger or a pen being in touch with the touch panel 70a is separated from the touch panel 70a, that is, the end of a touch (hereinafter referred to as a “touch-up”).
A state in which a finger or a pen is not in touch with the touch panel 70a (hereinafter referred to as a “touch-off”).

When a touch-down is detected, a touch-on is also detected at the same time. After a touch-down is detected, a touch-on is usually detected continuously unless a touch-up is detected. A touch-on is also detected when a touch-move is detected. Even if a touch-on is detected, a touch-move is not detected unless a touch position is moved. A touch-off is detected after a touch-up of all fingers or pens being in touch with the touch panel is detected.

These operations and states and the positional coordinates at which a finger or a pen is touch with the touch panel 70a are notified to the system control unit 50 via an internal bus. The system control unit 50 determines which operation has been performed on the touch panel 70a on the basis of the notified information. As for a touch-move, the moving direction of the finger or pen moving on the touch panel 70a can be determined for each of the vertical and horizontal components on the touch panel 70a on the basis of changes in the positional coordinates. When a touch-down, a certain amount of a touch-move, and a touch-up are sequentially performed on the touch panel 70a, it is assumed that a “stroke” is drawn. An operation of quickly drawing a stroke is referred to as a “flick”. A flick is an operation of quickly moving a finger over a certain distance while touching the touch panel 70a and then separating the finger as it is. In other words, a flick is an operation of quickly tracing on the touch panel 70a as if a finger flicks on the touch panel 70a. When a touch-move at least a predetermined speed over at least a predetermined distance is detected and a touch-up is subsequently detected as it is, it can be determined that a flick has been performed. When a touch-move at a speed lower than a predetermined speed over at least a predetermined distance is detected, it can be determined that a drag has been performed. The touch panel 70a may be any one of various types of touch panels such as a resistance film type, a capacitance type, a surface acoustic wave type, an infrared type, an electromagnetic induction type, an image recognition type, or an optical sensor type. Although there are a type in which a touch is detected when a finger or a pen comes into contact with the touch panel and a type in which a touch is detected when a finger or a pen comes close to the touch panel, either type may be used.

The system control unit 50 can detect a touch operation or a push operation on the AF-ON buttons 1 and 2 according to a notification (output information) from the AF-ON buttons 1 and 2. The system control unit 50 calculates the direction of movement of a finger or the like on the AF-ON buttons 1 and 2 in eight directions of up, down, left, right, upper left, lower left, upper right, and lower right on the basis of the output information of the AF-ON buttons 1 and 2. Furthermore, the system control unit 50 calculates the amount (hereinafter referred to as a movement amount (x,y)) of the movement of a finger or the like on the AF-ON buttons 1 and 2 in two-dimensional directions of an x-axis direction and ay-axis direction on the basis of the output information of the AF-ON buttons 1 and 2. The system control unit 50 can further detect the following operations or states on the AF-ON buttons 1 and 2. The system control unit 50 calculates the moving direction or the movement amount (x,y) and detects the following operations and states individually for the AF-ON buttons 1 and 2.
A finger or the like which is not in touch with the AF-ON button 1 or 2 newly touches the AF-ON button 1 or 2, that is the start of a touch (hereinafter referred to as a “touch-down”).
A state in which a finger or the like is in touch with the AF-ON button 1 or 2 (hereinafter referred to as a “touch-on”).
A finger or the like moves while touching the AF-ON button 1 or 2 (hereinafter referred to as a “touch-move”).
A finger or the like being in touch with the AF-ON button 1 or 2 is separated from the AF-ON button 1 or 2, that is, the end of a touch (hereinafter referred to as a “touch-up”).
A state in which a finger or the like is not in touch with the AF-ON button 1 or 2 (hereinafter referred to as a “touch-off”).

When a touch-down is detected, a touch-on is also detected at the same time. After a touch-down is detected, a touch-on is usually detected continuously unless a touch-up is detected. A touch-on is also detected when a touch-move is detected. Even if a touch-on is detected, a touch-move is not detected if the movement amount (x,y) is 0. A touch-off is detected after a touch-up of all fingers or the like being in touch with the AF-ON button is detected.

The system control unit 50 determines which operation (touch operation) has been performed on the AF-ON buttons 1 and 2 on the basis of these operations and states, the moving direction, and the movement amount (x,y). As for a touch-move, movement in the eight directions of up, down, left, right, upper left, lower left, upper right, and lower right or the two-dimensional directions of the x-axis direction and the y-axis direction as the movement of a finger or the like on the AF-ON buttons 1 and 2. The system control unit 50 determines that a slide operation has been performed when movement in any one of the eight directions or movement in one or both of the two-dimensional directions of the x-axis direction and the y-axis direction is detected. In the present embodiment, it is assumed that the AF-ON buttons 1 and 2 are infrared touch sensors. However, the AF-ON button may be another type of touch sensor such as a surface acoustic wave type, a capacitance type, an electromagnetic induction type, an image recognition type, or an optical sensor type.

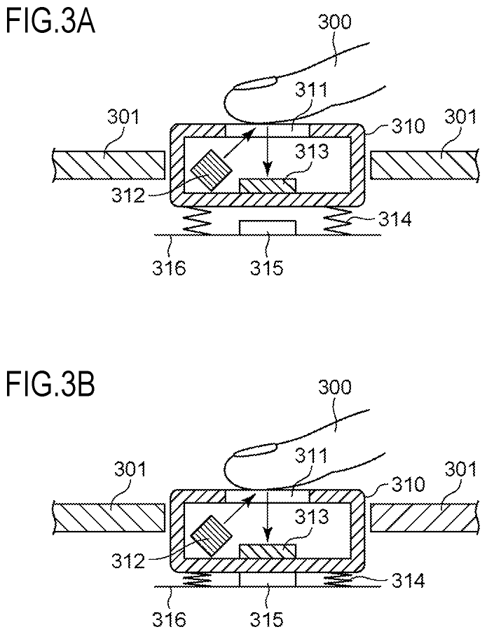

The structure of the AF-ON button 1 will be described with reference to FIGS. 3A and 3B. Since the structure of the AF-ON button 2 is similar to the structure of the AF-ON button 1, the description thereof will be omitted.

A cover 310 is an outer cover of the AF-ON button 1. A window 311 is a part of the outer cover of the AF-ON button 1 and transmits light projected from a light-projecting unit 312. The cover 310 projects further outward than the outer cover 301 of the camera 100 and can be pushed in. The light-projecting unit 312 is alight-emitting device such as a light-emitting diode that emits light toward the window 311. The light emitted from the light-projecting unit 312 is preferably light (infrared light) other than visible light. When a finger 300 touches the surface (an operation surface of the AF-ON button 1) of the window 311, the light emitted from the light-projecting unit 312 is reflected from the surface of the touching finger 300, and the reflected light is received (captured) by a light-receiving unit 313. The light-receiving unit 313 is an imaging sensor. On the basis of the image captured by the light-receiving unit 313, it is possible to detect whether an operating body (the finger 300) is not in contact with the operation surface of the AF-ON button 1, whether the operating body is in touch, and whether the touching operating body is moving in a touching state (a slide operation is performed). The cover 310 is an elastic member 314 and is provided on aground surface 316. When the finger 300 pushes the surface of the window 311 and the cover 310 is pushed in, the cover 310 touches a switch 315 for detecting a push. In this way, it is detected that the AF-ON button 1 is pushed.

A face detection function will be described. The system control unit 50 transmits a face detection target image to the image processing unit 24. Under the control of the system control unit 50, the image processing unit 24 applies a horizontal band-pass filter to the image data. Moreover, under the control of the system control unit 50, the image processing unit 24 applies a vertical band-pass filter to the processed image data. Edge components are detected from the image data by the horizontal and vertical band-pass filters.

After that, the system control unit 50 performs pattern matching on the detected edge components to extract candidate groups for eyes, nose, mouth, and ears. The system control unit 50 determines candidates that satisfy preset conditions (for example, the distance between two eyes, and an inclination, and the like) among the extracted candidate group for eyes as an eye pair and narrows down candidates having the eye pair as the eye candidate group. The system control unit 50 correlates the narrowed-down eye candidate group with other parts (nose, mouse, and ears) forming a face corresponding thereto and passing the correlation results to preset non-face condition filter to detect a face. The system control unit 50 outputs face information according to the face detection result and ends the processing. In this case, a character value such as the number of faces is stored in the system memory 52.

In this way, it is possible to analyze a LV image or an image being played to extract a character value of the image and detect subject information (detect a specific subject). In the present embodiment, the face is taken as an example of a specific subject. However, other subjects such as eyes, hands, torso, a specific individual, a moving object, or a character may be detected and be selected as a target of AF or the like.

FIG. 3A is a schematic diagram illustrating a state in which the finger 300 touches the operation surface of the AF-ON button 1 but the AF-ON button 1 is not pushed in. FIG. 3B is a schematic diagram illustrating a state in which the finger 300 presses the operation surface of the AF-ON button 1 whereby the AF-ON button 1 is pushed in, and it is detected that the AF-ON button 1 has been pressed. When the finger 300 is separated from the operation surface of the AF-ON button 1 from the pushed-in state of FIG. 3B, the AF-ON button 1 returns to the state of FIG. 3A in which the AF-ON button 1 is not in contact with the switch 315 by the force of the elastic member 314. Although an example in which the elastic member 314 is provided on the ground surface 316 has been described, the elastic member 314 may be provided on the outer cover 301 rather than the ground surface 316. Moreover, the AF-ON button 1 is not limited to the structure illustrated in FIGS. 3A and 3B but may have another structure as long as it can detect a push-in toward the operation surface and a touch operation on the operation surface.

An AF frame selectable in an OVF mode will be described. In an OVF mode, a user can select and set in advance any one of a plurality of select modes including at least the following select modes from a setting menu as an AF frame select mode (a range-finding area select mode).
One-point AF (arbitrary select) . . . A select mode in which a user selects one range-finding point used for a focusing operation (AF) from 191 range-finding points (focus adjustment areas). A range narrower than zone AF described later becomes a focus adjustment area.
Zone AF (arbitrary zone select) . . . A select mode in which a plurality of range-finding points is classified into nine range-finding zones (focus adjustment areas) and a user selects any one range-finding zone. Auto-select AF is performed using all range-finding points included in the selected zone. In auto-select AF, AF is performed so that a subject determined to be a subject to be automatically focused among subjects measured at a target range-finding point is focused. Basically, AF is performed so that a subject at the nearest distance is focused. However, conditions such as the position on a screen, a subject size, and a subject distance may betaken into consideration. A subject is more easily captured than one-point AF, and it is easy to focus when photographing a moving subject. Moreover, since a zone to be focused is narrowed down, it is possible to prevent a subject at an unintended position in the composition from being focused.
Auto-select AF . . . A mode in which the above-mentioned auto-select AF is performed using all range-finding points. The range-finding point used for AF is automatically determined from all range-finding points without the user selecting an AF area.

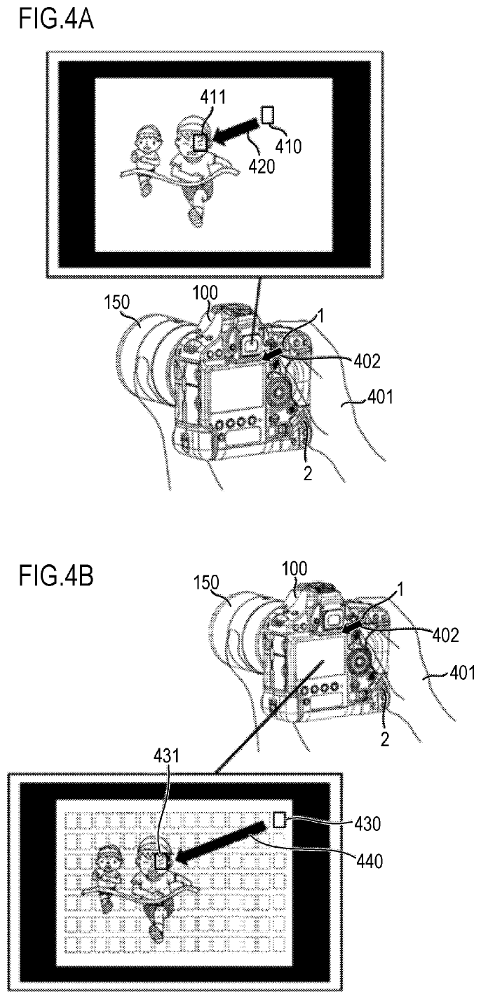

FIGS. 4A and 4B are diagrams illustrating an operation example of the camera 100. In this example, it is assumed that user-based calibration described later has not been executed on the AF-ON button 1. FIG. 4A illustrates an example of a screen displayed on the in-finder display portion 41 and FIG. 4B illustrates an example of a screen displayed on the display unit 28 (a backside monitor). In FIGS. 4A and 4B, a user holds the first grip portion 101 with a hand 401 and performs a slide operation of moving a touch position in the direction of an arrow 402 with respect to the AF-ON button 1 using a thumb 403. The camera 100 (the system control unit 50) moves the displayed range-finding frame according to the slide operation.

In FIG. 4A, a range-finding frame 410 is a range-finding frame before movement displayed on the in-finder display portion 41, and a range-finding frame 411 is a range-finding frame after movement. An arrow 420 indicates the direction of movement (movement from the position of the range-finding frame 410 toward the position of the range-finding frame 411) of the range-finding frame according to the slide operation and is the same direction as the direction (the moving direction of the touch position) of the slide operation indicated by the arrow 402.

In FIG. 4B, a range-finding frame 430 is a range-finding frame before movement displayed on the display unit 28 and a range-finding frame 431 is a range-finding frame after movement. An arrow 440 indicates the direction of movement (movement from the position of the range-finding frame 430 toward the position of the range-finding frame 431) of the range-finding frame according to the slide operation and is the same direction as the direction (the moving direction of the touch position) of the slide operation indicated by the arrow 402.

Here, in a move operation of moving an operating body (a finger or the like touching a touch operating member) or an operating member (a mouse or the like), the habit of moving a moving target is generally different depending on a user. Due to factors such as differences in habits of each user, the direction of a move operation intended by a user may differ from an operating direction detected by the device, and a move operation in the direction intended by the user may not be performed. Such a problem occurs in a slide operation on the AF-ON buttons 1 and 2. Therefore, in the present embodiment, calibration of the AF-ON buttons 1 and 2 is performed so that the habit of moving the thumb 403 in a slide operation on the AF-ON buttons 1 and 2 is taken into consideration. In this way, even when a user who wants to move the range-finding frame in the direction of the arrows 420 and 440 moves the touch position in a direction different from the direction of the arrow 402 due to his or her habit, it is possible to move the range-finding frame in the direction of the arrows 420 and 440.

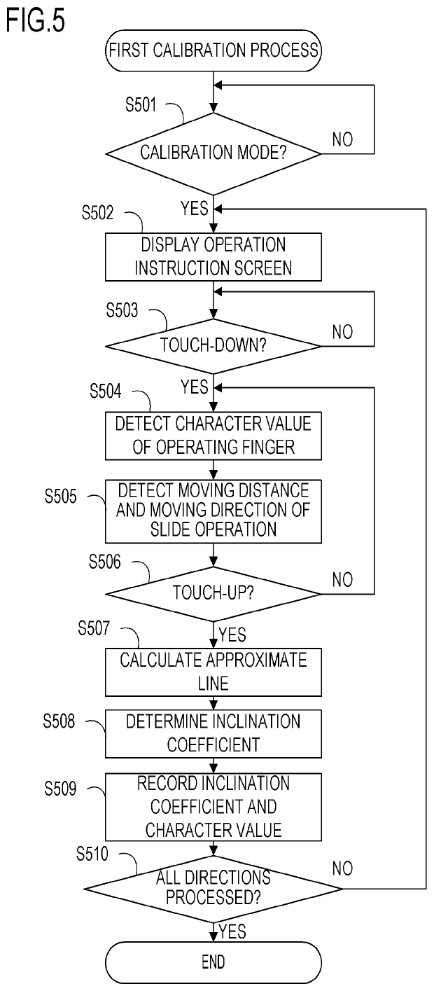

FIG. 5 illustrates a flowchart of a first calibration process for an AF-ON button. This processing is realized when a program recorded on the nonvolatile memory 56 is loaded into the system memory 52 and is executed by the system control unit 50. Although a first calibration process for the AF-ON button 1 is described in FIG. 5, similar processing is performed for the AF-ON button 2.

In S501, the system control unit 50 determines whether a calibration mode for calibrating the AF-ON button 1 is set. It is waited for the calibration mode to be set, and the flow proceeds to S502 when the calibration mode is set.

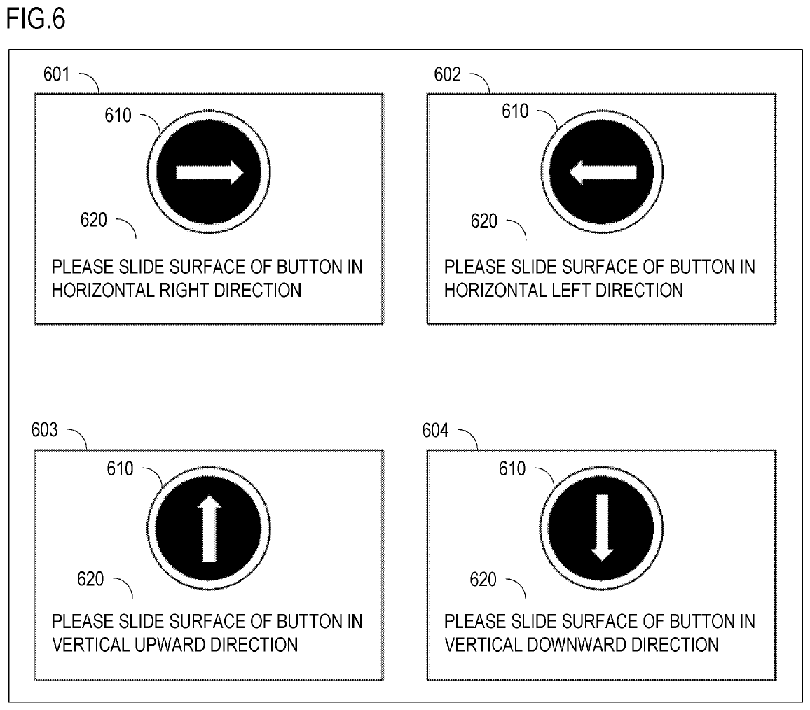

In S502, the system control unit 50 displays an operation instruction screen on at least one of the display unit 28 and the in-finder display portion 41 in order to prompt the user to perform a slide operation of drawing a linear trajectory in a specific direction. FIG. 6 is a diagram illustrating an example of the operation instruction screen. Each of operation instruction screens 601 to 604 displays an item 610 (icon) indicating the direction of a slide operation on the AF-ON button 1 and an item 620 (text) indicating a method of operating the AF-ON button 1. The contents of the items 610 and 620 are different between the operation instruction screens 601 to 604. The operation instruction screen 601 is a screen for causing the user to perform a slide operation in the horizontal right direction, and the operation instruction screen 602 is a screen for causing the user to perform a slide operation in the horizontal left direction. The operation instruction screen 603 is a screen for causing the user to perform a slide operation in a vertical upward direction, and the operation instruction screen 604 is a screen for causing the user to perform a slide operation in a vertical downward direction. In S502, any one of the operation instruction screens 601 to 604 is displayed.

In S503, the system control unit 50 determines whether a touch-down on the AF-ON button 1 is detected. It is waited for a touch-down to be detected and the flow proceeds to S504 when a touch-down is detected.

In S504, the system control unit 50 detects a character value of a finger performing a touch operation on the AF-ON button 1 using optical information (an image captured by the light-receiving unit 313) from the AF-ON button 1 and records the character value in the system memory 52. The character value is used for user authentication for identifying (determining) a user who has performed a slide operation (a slide operation in a mode different from the calibration mode) after calibration and is a fingerprint or the like, for example. The detection position of the character value is used as a touch position.

In S505, the system control unit 50 detects a moving distance and a moving direction of the finger (the touch position) in the slide operation from a change in the detection position of the character value detected in S504 and records the same in the system memory 52.

In S506, the system control unit 50 determines whether a touch-up from the AF-ON button 1 is detected. The processing of S504 and S505 is repeated until a touch-up is detected, and the flow proceeds to S507 when a touch-up is detected.

In S507, the system control unit 50 calculates an approximate line that approximates the trajectory of the performed slide operation from the moving direction detected in S505.

In S508, the system control unit 50 compares a designated line (a specific direction designated in the operation instruction screen displayed in S502) and the approximate line calculated in S507 to determine an inclination coefficient. The inclination coefficient is a value indicating an inclination such as a coefficient a of the equation of a straight line (Y=aX+b) and an angular difference (the angle between the approximate line and the designated line) between the approximate line and the designated line.

In S509, the system control unit 50 records the inclination coefficient calculated in S508 in the nonvolatile memory 56 as reference coordinate axis information for determining the direction of the slide operation and reference straight line information for determining whether the slide operation is in the specific direction designated in S502. Furthermore, the system control unit 50 records the character value detected in S504 in the nonvolatile memory 56 so that the user authentication can be performed. The character value recorded may be one or a plurality of items, and for example, a character value during a touch-on and a character value during a touch-up are recorded.

In S510, the system control unit 50 determines whether the inclination coefficient has been recorded for all directions (four directions designated in the operation instruction screens 601 to 604). When the inclination coefficient is recorded for all directions, the first calibration process ends, and otherwise, the flow proceeds to S502. That is, the processing of S502 to S510 is repeated so that the inclination coefficient is determined while switching the operation instruction screen to be displayed, and the first calibration process ends when the inclination coefficient is recorded for all directions. The processing of S509 may be controlled so that the character value acquired in the processing for some directions (for example, one direction) is recorded as the character value for user authentication, and may not.

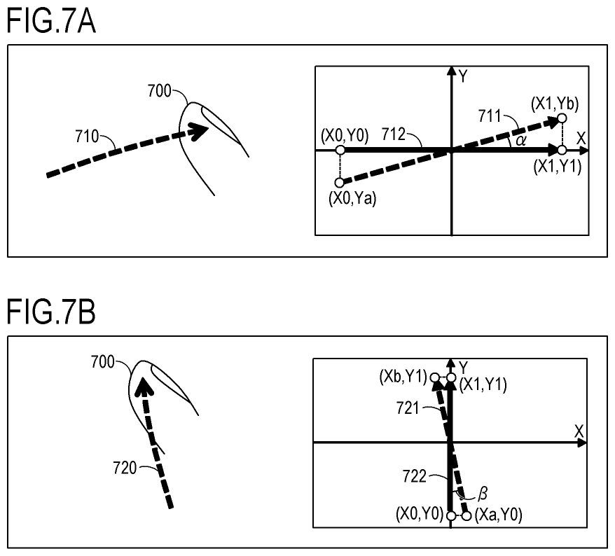

FIGS. 7A and 7B are diagrams illustrating a specific example of the first calibration process. FIG. 7A illustrates a case in which the operation instruction screen 601 for causing the user to perform a slide operation in the horizontal right direction is displayed, and FIG. 7B illustrates a case in which the operation instruction screen 603 for causing the user to perform a slide operation in the vertical upward direction is displayed.

In FIG. 7A, the user performs a slide operation of drawing a trajectory 710 using a thumb 700. The trajectory 710 (an approximate line 711 of the trajectory 710) is not in a parallel relationship with a horizontal right direction 712 designated in the operation instruction screen 601 but is in the upper right direction. In this case, the angle α of the approximate line 711 with respect to the horizontal right direction 712 is recorded as information (reference straight line information; reference coordinate axis information) of the approximate line 711.

In FIG. 7B, the user performs a slide operation of drawing a trajectory 720 using a thumb 700. The trajectory 720 (an approximate line 721 of the trajectory 720) is not in a parallel relationship with a vertical upward direction 722 designated in the operation instruction screen 603 but is in the upper left direction. In this case, the angle β of the approximate line 721 with respect to the vertical upward direction 722 is recorded as information (reference straight line information; reference coordinate axis information) of the approximate line 721.

Here, it is assumed that the user performs on the operation instruction screen 602 a slide operation of drawing a trajectory being in a parallel relationship with the horizontal left direction designated in the operation instruction screen 602. In this case, the angle (=0°) with respect to the horizontal left direction is recorded. As a result, when a slide operation of drawing a trajectory in a horizontal left direction (a direction opposite to the horizontal right direction 712) is performed in a first slide response process described later, movement (processing based on the horizontal left direction) of the range-finding frame in the horizontal left direction is executed. On the other hand, since the angle (α≠0°) of the allocation process 711 with respect to the horizontal right direction 712 is recorded, even when a slide operation of drawing a trajectory in the horizontal right direction 712 is performed, movement (processing based on the horizontal right direction 1112) of the range-finding frame in the horizontal right direction 712 is not executed. For example, the range-finding frame is moved in a direction inclined at the angle α with respect to the horizontal right direction 712. The same is applied to when the user performs a slide operation of drawing a trajectory being in a parallel relationship with a vertical downward direction designated in the operation instruction screen 604 on the display of the operation instruction screen 604. In the first slide response process, when a slide operation of drawing a trajectory in the vertical downward direction (a direction opposite to the vertical upward direction 722) is performed, the range-finding frame is moved in the vertical downward direction. On the other hand, since the angle (β≠0°) of the approximate line 721 with respect to the vertical upward direction 722 is recorded, even when a slide operation of drawing a trajectory in the vertical upward direction 722 is performed, the range-finding frame is not moved in the vertical upward direction 722.

Furthermore, it is assumed that the trajectory 710 (the approximate line 711) and the trajectory 720 (the approximate line 721) are not in a vertical relationship (that is, α≠β). In this case, reference coordinate axis information including a first axis (angle α) based on the trajectory 710 and a second axis (angle β) based on the trajectory 720, which are not vertical to each other, is recorded. Here, in the first slide response process described later, it is assumed that when a slide operation of drawing a trajectory inclined at a specific angle with respect to the first axis is performed, processing based on the direction inclined at the specific angle with respect to the first axis is executed. However, when a slide operation of drawing a trajectory inclined at a specific angle with respect to the second axis is performed, processing based on the direction inclined at the specific angle with respect to the second axis is not executed.

As an example, a case where α=40° and β=100 will be considered. Moreover, a case of performing processing based on a direction closest to the trajectory of a slide operation among an axial direction parallel to the first and second axes and a non-axial direction that divides between the first and second axes will be considered. In this case, the width (angle) of a first quadrant and a third quadrant defined by the first and second axes is 50°, and the width (angle) of a second quadrant and a fourth quadrant defined by the first and second axes is 130°. Moreover, the angle of a non-axial direction passing through the first and third quadrants for the first axis is 25°, and the angle of a non-axial direction passing through the second and fourth quadrants for the second axis is 65°. When a slide operation of drawing a trajectory inclined at 25° with respect to the first axis is performed, processing based on a non-axial direction (a direction inclined at 25° with respect to the first axis) passing through the first and third quadrants is executed. On the other hand, when a slide operation of drawing a trajectory inclined at 25° with respect to the second axis is performed, processing based on a direction inclined at 25° with respect to the first axis is not executed, but processing based on an axial direction parallel to the second axis is executed.

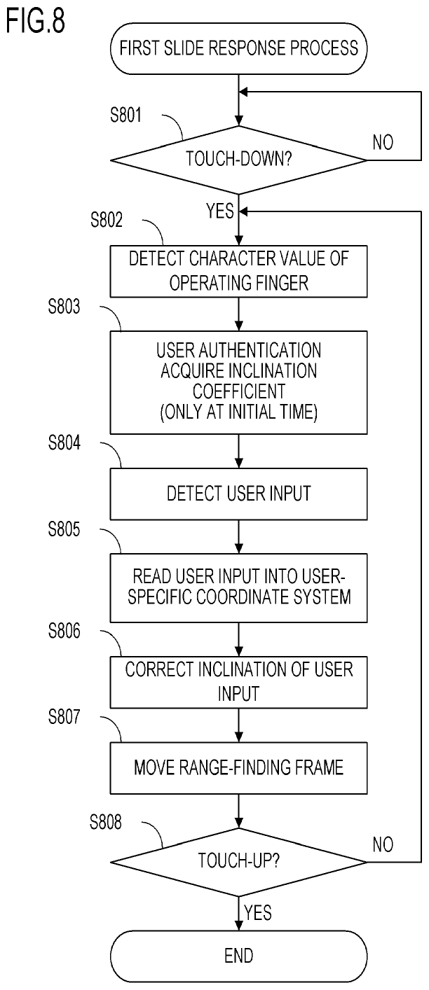

FIG. 8 illustrates a flowchart of a first slide response process for the AF-ON button. The first slide response process is a process of executing a function (example: movement of a range-finding frame (AF frame)) corresponding to a slide operation of touching an operation surface and performing a touch-move without pushing in the AF-ON button. This processing is realized when a program recorded on the nonvolatile memory 56 is loaded into the system memory 52 and is executed by the system control unit 50. The processing of FIG. 8 starts when a mode (a capturing mode or the like) different from the calibration mode is set after the first calibration process is performed. When a capturing mode or the like is set, another processing (for example processing corresponding to an operation on another operating member included in the operating unit 70 or processing corresponding to a push-in of the AF-ON button) is also performed in parallel, but the description thereof will be omitted. Moreover, although a response process for a slide operation on the AF-ON button 1 is described in FIG. 8, similar processing is performed for the AF-ON button 2. However, it is assumed that, when a touch-on on the AF-ON button 1 is detected, a slide response process for the AF-ON button 2 is not performed. In this way, it is possible to prevent a malfunction due to a conflict between the AF-ON buttons 1 and 2 (a slide operation on the AF-ON button 1 is prioritized).

In S801, the system control unit 50 determines whether a touch-down on the AF-ON button 1 is detected. It is waited for a touch-down to be detected, and the flow proceeds to S802 when a touch-down is detected.

In S802, the system control unit 50 detects a character value of a finger performing a touch operation on the AF-ON button 1 using optical information (an image captured by the light-receiving unit 313) from the AF-ON button 1 and records the character value in the system memory 52.

In S803, the system control unit 50 detects a character value that matches the character value detected in S802 from a plurality of character values recorded in the nonvolatile memory 56 in the first calibration process (FIGS. 7A and 7B) and identifies (determines) a current user (user authentication). For example, a character value of which the similarity with the character value detected in S802 is at least a threshold, a character value closest to the character value detected in S802, and the like are detected as the character value of the current user. The system control unit 50 acquires information (reference straight line information; reference coordinate axis information) corresponding to the current user (the character value matching the character value detected in S802) from the nonvolatile memory 56 and records the same in the system memory 52. Although the processing of S802 to S808 is repeated until a touch-up from the AF-ON button 1 is detected, the processing of S803 may be performed only at the initial time.

In S804, the system control unit 50 detects a change in the detection position of the character value detected in S802 (that is, a trajectory drawn by the slide operation) as a user input.

In S805, the system control unit 50 reads the user input detected in S804 into a user-specific coordinate system (a coordinate system corresponding to the information (reference straight line information; reference coordinate axis information) acquired in S803) obtained in the first calibration process (FIGS. 7A and 7B).

In S806, the system control unit 50 corrects the user input detected in S804 by correcting the coordinate system so that an inclination of the axis of the user-specific coordinate system (the coordinate system corresponding to the information (reference straight line information; reference coordinate axis information) acquired in S803) is eliminated.

In S807, the system control unit 50 moves the range-finding frame in the direction of the user input corrected in S806.

The processing of S805 may be regarded as comparison between the reference coordinate axis information (reference straight line information) and the trajectory of the slide operation performed. The processing of S806 may be regarded as processing of determining the direction of the slide operation performed on the basis of the comparison in S805. The processing of S807 may also be regarded as execution of processing based on the direction determined in S806.

In S808, the system control unit 50 determines whether a touch-up from the AF-ON button 1 is detected. The processing of S802 to S808 is repeated until a touch-up is detected, and the first slide response process ends when a touch-up is detected.

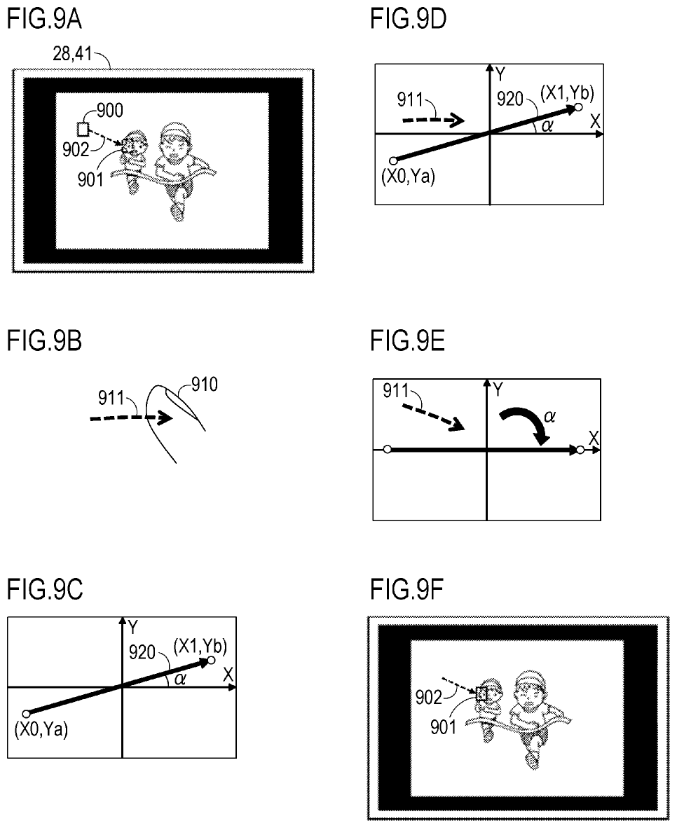

FIGS. 9A to 9F are diagrams illustrating a specific example of the first slide response process. FIG. 9A illustrates a screen displayed on at least one of the display unit 28 and the in-finder display portion 41. In the screen of FIG. 9A, a range-finding frame 900 is displayed on an LV image. In this example, it is assumed that the user wants to move the range-finding frame 900 in the direction of an arrow 902 to obtain a range-finding frame 901.

FIG. 9B illustrates a slide operation intended to move the range-finding frame 900 in the direction of the arrow 902. In the slide operation of FIG. 9B, a trajectory 911 is drawn by a thumb 910. Although the direction (the direction of the arrow 902) intended by the user is a lower right direction, the direction of the trajectory 911 (the user input) is approximately a horizontal right direction due to the habit of the user.

FIG. 9C illustrates a user-specific coordinate system obtained in the first calibration process (FIGS. 7A and 7B). The coordinate system of FIG. 9C includes an axis 920 (line) inclined at an angle α with respect to a horizontal right direction as an axis corresponding to the horizontal right direction. FIG. 9D illustrates a state in which the trajectory 911 of FIG. 9B is read into the coordinate system of FIG. 9C.

FIG. 9E illustrates correction of the trajectory 911. In this correction, the trajectory 911 is inclined at the angle α in a direction (lower side) opposite to the direction (upper side) in which the axis 920 is inclined with respect to the horizontal right direction so that the direction of the axis 920 is a horizontal right direction. As a result, the direction of the trajectory 911 after correction is approximately identical to the lower right direction (the direction of the arrow 902 in FIG. 9A) intended by the user.

FIG. 9F illustrates a screen after the range-finding frame 900 (FIG. 9A) is moved according to the slide operation of FIG. 9B. Due to the correction in FIG. 9E, the slide operation in the lower right direction is detected in the screen of FIG. 9F, the range-finding frame 900 is moved in the lower right direction (the direction of the arrow 902) intended by the user, and a range-finding frame 901 is obtained.

As described above, according to the first slide response process (FIG. 8) subsequent to the first calibration process (FIGS. 7A and 7B), it is possible to move the range-finding frame in a direction closer to the user's intention by taking the habit of the user drawing a trajectory in a direction inclined with respect to the intended direction into consideration. It is possible to eliminate the dissatisfaction of the user resulting from the movement of the range-finding frame in the direction inclined with respect to the direction intended by the user.

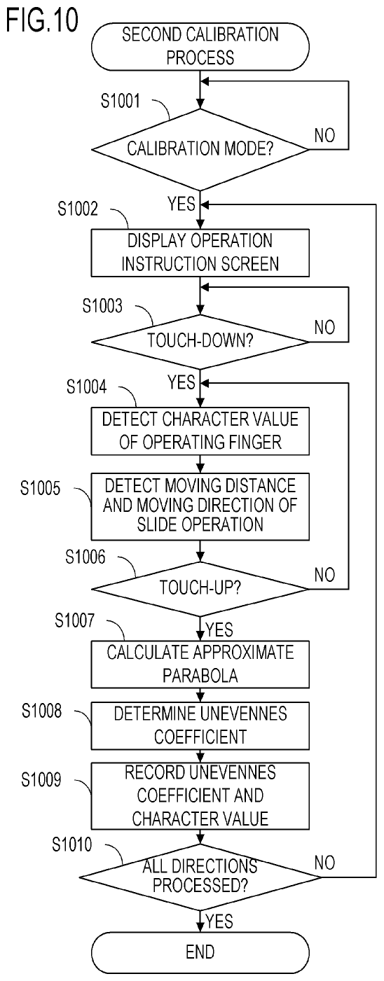

FIG. 10 illustrates a flowchart of a second calibration process for the AF-ON button. This processing is realized when a program recorded on the nonvolatile memory 56 is loaded into the system memory 52 and is executed by the system control unit 50. Although a second calibration process for the AF-ON button 1 is described in FIG. 10, similar processing is performed for the AF-ON button 2.

In S1001, the system control unit 50 determines whether a calibration mode for calibrating the AF-ON button 1 is set. It is waited for the calibration mode to be set, and the flow proceeds to S1002 when the calibration mode is set.

In S1002, the system control unit 50 displays an operation instruction screen on at least one of the display unit 28 and the in-finder display portion 41 in order to prompt the user to perform a slide operation of drawing a linear trajectory in a specific direction. Similarly to S502 in FIG. 5, any one of the operation instruction screens 601 to 604 in FIG. 6 is displayed.

In S1003, the system control unit 50 determines whether a touch-down on the AF-ON button 1 is detected. It is waited for a touch-down to be detected and the flow proceeds to S1004 when a touch-down is detected.

In S1004, the system control unit 50 detects a character value (a fingerprint or the like) of a finger performing a touch operation on the AF-ON button 1 using optical information (an image captured by the light-receiving unit 313) from the AF-ON button 1 and records the character value in the system memory 52.

In S1005, the system control unit 50 detects a moving distance and a moving direction of the finger (the touch position) in the slide operation from a change in the detection position of the character value detected in S1004 and records the same in the system memory 52.

In S1006, the system control unit 50 determines whether a touch-up from the AF-ON button 1 is detected. The processing of S1004 and S1005 is repeated until a touch-up is detected, and the flow proceeds to S1007 when a touch-up is detected.

In S1007, the system control unit 50 calculates an approximate parabola that approximates the trajectory of the performed slide operation from the moving direction detected in S1005. A curve different from the parabola may be calculated as a curve that approximates the trajectory of the slide operation.

In S1008, the system control unit 50 compares a designated line (a specific direction designated in the operation instruction screen displayed in S1002) and the approximate parabola calculated in S1007 to determine an unevenness coefficient. The unevenness coefficient is a value indicating the degree of curvature (distortion) of an approximate parabola such as a coefficient a of the equation of a parabola (Y=aX²+b) and the designated line.

In S1009, the system control unit 50 records the unevenness coefficient calculated in S1008 in the nonvolatile memory 56 as reference curve information for determining whether the slide operation is in the specific direction designated in S1002. Furthermore, the system control unit 50 records the character value detected in S1004 in the nonvolatile memory 56 so that the user authentication can be performed. The character value recorded may be one or a plurality of items, and for example, a character value during a touch-on and a character value during a touch-up are recorded.

In S1010, the system control unit 50 determines whether the unevenness coefficient has been recorded for all directions (four directions designated in the operation instruction screens 601 to 604). When the unevenness coefficient is recorded for all directions, the second calibration process ends, and otherwise, the flow proceeds to S1002. That is, the processing of S1002 to S1010 is repeated so that the unevenness coefficient is determined while switching the operation instruction screen to be displayed, and the second calibration process ends when the unevenness coefficient is recorded for all directions. The processing of S1010 may be controlled so that the character value acquired in the processing for some directions (for example, one direction) is recorded as the character value for user authentication, and may not.

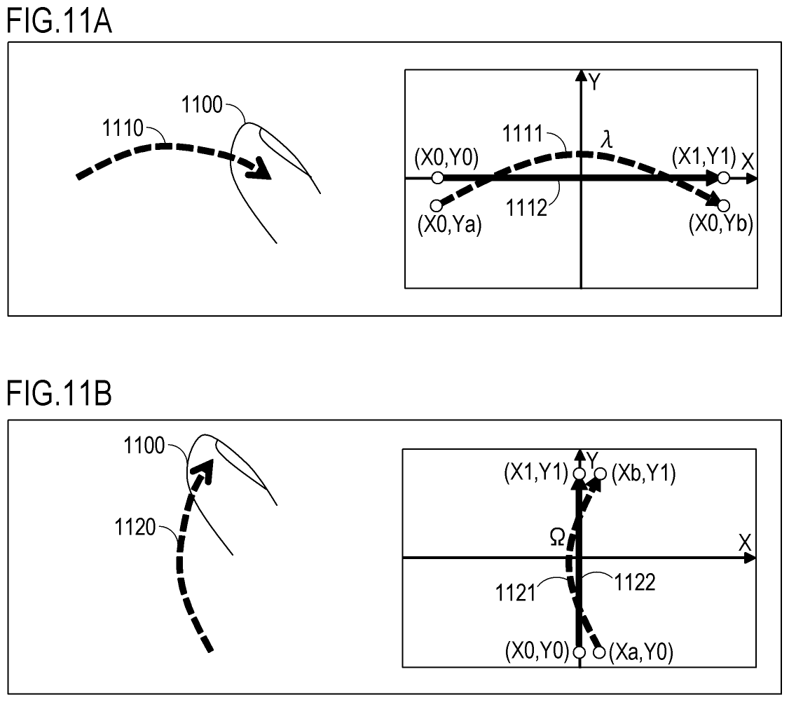

FIGS. 11A and 11B are diagrams illustrating a specific example of the second calibration process. FIG. 11A illustrates a case in which the operation instruction screen 601 for causing the user to perform a slide operation in the horizontal right direction is displayed, and FIG. 11B illustrates a case in which the operation instruction screen 603 for causing the user to perform a slide operation in the vertical upward direction is displayed.

In FIG. 11A, the user performs a slide operation of drawing a trajectory 1110 using a thumb 110. The trajectory 1110 is curved from a horizontal right direction 1112 designated in the operation instruction screen 601. In this case, the unevenness coefficient λ indicating the degree of curvature of the approximate parabola 1111 is recorded as information (reference curve information) of the approximate parabola 1111 that approximates the trajectory 1110.

In FIG. 11B, the user performs a slide operation of drawing a trajectory 1120 using a thumb 1100. The trajectory 1120 is curved from a vertical upward direction 1122 designated in the operation instruction screen 603. In this case, the unevenness coefficient Ω indicating the degree of curvature of the approximate parabola 1121 is recorded as information (reference curve information) of the approximate parabola 1121 that approximates the trajectory 1120.

Here, it is assumed that the user performs on the operation instruction screen 602 a slide operation of drawing a trajectory being in a parallel relationship with the horizontal left direction designated in the operation instruction screen 602. In this case, an unevenness coefficient indicating that the trajectory is not curved is recorded as the unevenness coefficient corresponding to the horizontal left direction. As a result, when a slide operation of drawing a trajectory in a horizontal left direction (a direction opposite to the horizontal right direction 1112) is performed in a second slide response process described later, movement (processing based on the horizontal left direction) of the range-finding frame in the horizontal left direction is executed. On the other hand, the unevenness coefficient λ indicating the trajectory is curved is recorded as the unevenness coefficient corresponding to the horizontal right direction 1112. Therefore, even when a slide operation of drawing a trajectory in the horizontal right direction 1112 is performed, movement (processing based on the horizontal right direction 1112) of the range-finding frame in the horizontal right direction 1112 is not executed. For example, the range-finding frame is moved so as to be curved with respect to the horizontal right direction 1112. The same is applied to when the user performs a slide operation of drawing a trajectory being in a parallel relationship with a vertical downward direction designated in the operation instruction screen 604 on the display of the operation instruction screen 604. In the second slide response process, when a slide operation of drawing a trajectory in the vertical downward direction (a direction opposite to the vertical upward direction 1122) is performed, the range-finding frame is moved in the vertical downward direction. On the other hand, since the unevenness coefficient Ω (with curvature) corresponding to the vertical upward direction 1122 is recorded, even when a slide operation of drawing a trajectory in the vertical upward direction 1122 is performed, the range-finding frame is not moved in the vertical upward direction 1122.

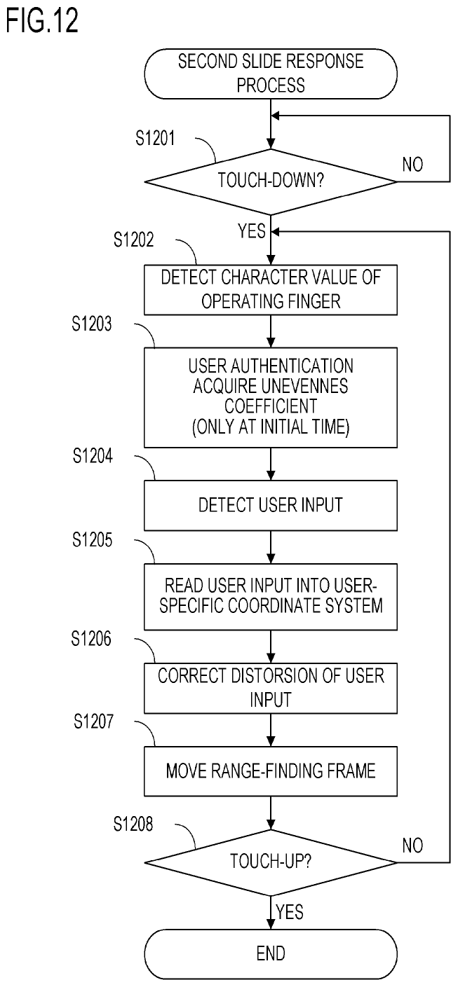

FIG. 12 illustrates a flowchart of a second slide response process for the AF-ON button. The second slide response process is a process of executing a function (example: movement of a range-finding frame (AF frame)) corresponding to a slide operation of touching an operation surface and performing a touch-move without pushing in the AF-ON button. This processing is realized when a program recorded on the nonvolatile memory 56 is loaded into the system memory 52 and is executed by the system control unit 50. The processing of FIG. 12 starts when a mode (a capturing mode or the like) different from the calibration mode is set after the second calibration process is performed. When a capturing mode or the like is set, another processing (for example processing corresponding to an operation on another operating member included in the operating unit 70 or processing corresponding to a push-in of the AF-ON button) is also performed in parallel, but the description thereof will be omitted. Moreover, although a response process for a slide operation on the AF-ON button 1 is described in FIG. 12, similar processing is performed for the AF-ON button 2. However, it is assumed that, when a touch-on on the AF-ON button 1 is detected, a slide response process for the AF-ON button 2 is not performed. In this way, it is possible to prevent a malfunction due to a conflict between the AF-ON buttons 1 and 2 (a slide operation on the AF-ON button 1 is prioritized).

In S1201, the system control unit 50 determines whether a touch-down on the AF-ON button 1 is detected. It is waited for a touch-down to be detected, and the flow proceeds to S1202 when a touch-down is detected.

In S1202, the system control unit 50 detects a character value of a finger performing a touch operation on the AF-ON button 1 using optical information (an image captured by the light-receiving unit 313) from the AF-ON button 1 and records the character value in the system memory 52.

In S1203, the system control unit 50 detects a character value that matches the character value detected in S1202 from a plurality of character values recorded in the nonvolatile memory 56 in the second calibration process (FIG. 10) and identifies (determines) a current user (user authentication). The system control unit 50 acquires information (reference curve information) corresponding to the current user (the character value matching the character value detected in S1202) from the nonvolatile memory 56 and records the same in the system memory 52. Although the processing of S1202 to S1208 is repeated until a touch-up from the AF-ON button 1 is detected, the processing of S1203 may be performed only at the initial time.

In S1204, the system control unit 50 detects a change in the detection position of the character value detected in S1202 (that is, a trajectory drawn by the slide operation) as a user input.

In S1205, the system control unit 50 reads the user input detected in S1204 into a user-specific coordinate system (a coordinate system corresponding to the information (reference curve information) acquired in S1203) obtained in the second calibration process (FIG. 10).

In S1206, the system control unit 50 corrects the user input detected in S1204 by correcting the coordinate system so that distortion of the axis of the user-specific coordinate system (the coordinate system corresponding to the information (reference curve information) acquired in S1203) is eliminated.

In S1207, the system control unit 50 moves the range-finding frame in the direction of the user input corrected in S1206.

The processing of S1205 may be regarded as comparison between the reference curve information and the trajectory of the slide operation performed. The processing of S1206 may be regarded as processing of determining the direction of the slide operation performed on the basis of the comparison in S1205. The processing of S1207 may also be regarded as execution of processing based on the direction determined in S1206.

In S1208, the system control unit 50 determines whether a touch-up from the AF-ON button 1 is detected. The processing of S1202 to S1208 is repeated until a touch-up is detected, and the second slide response process ends when a touch-up is detected.

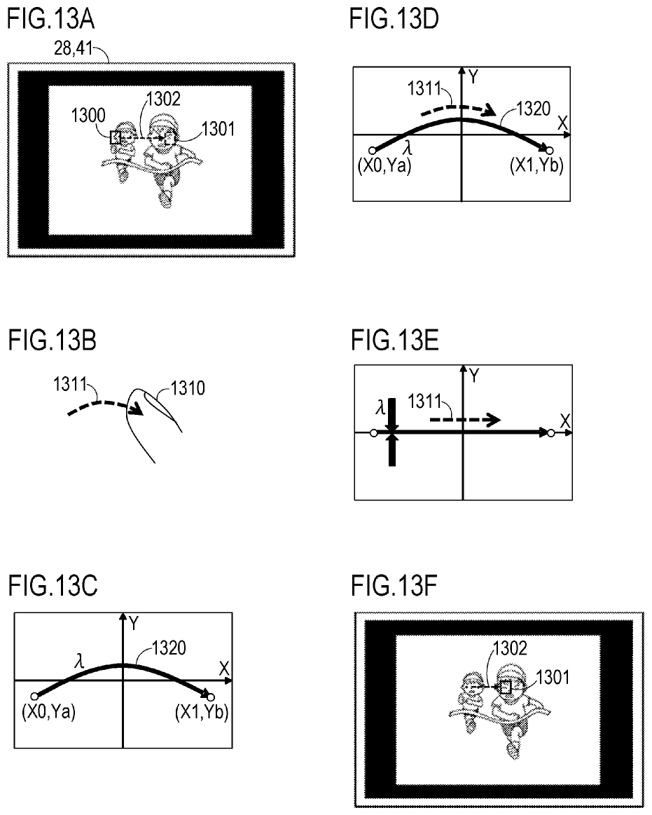

FIGS. 13A to 13F are diagrams illustrating a specific example of the second slide response process. FIG. 13A illustrates a screen displayed on at least one of the display unit 28 and the in-finder display portion 41. In the screen of FIG. 13A, a range-finding frame 1300 is displayed on an LV image. In this example, it is assumed that the user wants to move the range-finding frame 1300 in the direction of an arrow 1302 to obtain a range-finding frame 1301.

FIG. 13B illustrates a slide operation intended to move the range-finding frame 1300 in the direction of the arrow 1302. In the slide operation of FIG. 13B, a trajectory 1311 is drawn by a thumb 1310. Although the direction (the direction of the arrow 1302) intended by the user is a horizontal right direction, the direction of the trajectory 1311 (the user input) is curved to be convex upward due to the habit of the user.

FIG. 13C illustrates a user-specific coordinate system obtained in the second calibration process (FIG. 10). The coordinate system of FIG. 13C includes an axis 1320 (parabola) curved to be convex upward as an axis corresponding to the horizontal right direction. FIG. 13D illustrates a state in which the trajectory 1311 of FIG. 13B is read into the coordinate system of FIG. 13C.

FIG. 13E illustrates correction of the trajectory 1311. In this correction, the trajectory 1311 is deformed in a direction opposite to the direction in which the axis 1320 is curved so that the distortion of the axis 1320 is eliminated. As a result, the direction of the trajectory 1311 after correction is approximately identical to the horizontal right direction (the direction of the arrow 1302 in FIG. 13A) intended by the user. The direction of the axis 1320 is identical to the horizontal right direction.

FIG. 13F illustrates a screen after the range-finding frame 1300 (FIG. 13A) is moved according to the slide operation of FIG. 13B. Due to the correction in FIG. 13E, the slide operation in the horizontal right direction is detected in the screen of FIG. 13F, the range-finding frame 1300 is moved in the horizontal right direction (the direction of the arrow 1302) intended by the user, and a range-finding frame 1301 is obtained.

As described above, according to the second slide response process subsequent to the second calibration process, it is possible to move the range-finding frame in a direction closer to the user's intention by taking the habit of the user drawing a trajectory curved (distorted) with respect to the intended direction into consideration. It is possible to eliminate the dissatisfaction of the user resulting from the movement of the range-finding frame to be curved with respect to the direction intended by the user.

Although the correction (conversion) is performed from the trajectory of the slide operation to determine the direction of the slide operation, the movement amount of the slide operation is preferably determined without performing the correction (conversion). For example, it is preferable that the length of the trajectory of the slide operation is used as the movement amount of the slide operation as it is. By doing so, it is possible to suppress a change in the moving speed of the range-finding frame resulting from the correction (elimination of distortion).

A calibration process in which the first and second calibration processes are combined may be executed. For example, after a touch-up is detected, an approximate line and an approximate parabola that approximate the trajectory of a slide operation may be determined, and an inclination coefficient based on the approximate line and an unevenness coefficient based on the approximate parabola may be recorded. Similarly, a slide response process in which the first and second slide response processes are combined may be executed. For example, after the distortion of the trajectory of the slide operation may be eliminated (reduced) on the basis of the unevenness coefficient, the inclination may be corrected on the basis of the inclination coefficient.

The present invention is not limited to a slide operation on an AF-ON button but may be applied to an operation on another operating member. For example, a slide operation on a touch panel or a touch panel may be detected, and processing similar to the processing (control) may be performed with respect to the slide operation. Movement of an operating member itself such as a mouse or a motion controller may be detected in a wired or wireless manner and the processing may be performed with respect to the movement. Movement of the hand (an operating body) of a user such as a spatial gesture may be detected in a non-contact manner, and the processing may be performed with respect to the movement. The present invention can be applied to an arbitrary electronic apparatus as long as the electronic apparatus detects movement of an operating body (a finger, a pen, a hand, or the like) and movement of an operating member (a mouse, a motion controller, or the like) and execute processing.

While the present invention has been described in detail on the basis of preferred embodiments thereof, the present invention is not limited to these specific embodiments and various modes without departing from the scope of the invention are also included in the present invention. Furthermore, the embodiments described above simply represent an exemplary embodiment of the present invention and the embodiments may also be combined with each other.

Various controls described to be performed by the system control unit 50 may be performed by one piece of hardware or a plurality of pieces of hardware (for example, a plurality of processors or circuits) may control the entire apparatus by sharing the processing.

While an example in which the present invention is applied to an imaging apparatus has been described in the above-described embodiment, the present invention is not limited to this example and can be applied to any electronic apparatus having an operation detection function of detecting a move operation. For example, the present invention can be applied to a personal computer, a PDA, a mobile phone terminal, a mobile image viewer, a printer apparatus, a digital photo frame, a music player, a game device, an electronic book reader, and the like. Moreover, the present invention can be applied to a video player, a display apparatus (including a projection apparatus), a tablet terminal, a smartphone, an AI speaker, a home electrical appliance, a vehicle-mounted apparatus, and the like.

The present invention is not limited to an imaging apparatus body but can be applied to a control device that communicates with an imaging apparatus (including a network camera) via cable or wireless communication and controls the imaging apparatus remotely. Examples of the device that controls the imaging apparatus remotely include a smartphone, a tablet PC, a desktop PC, and the like. The imaging apparatus can be controlled remotely by notifying a command for making various operations and settings from the control device to the imaging apparatus on the basis of an operation performed on the control device or processing performed on the control device. Moreover, a live-view image captured by the imaging apparatus may be received via cable or wireless communication so that the image can be displayed on the control device.

According to the present invention, it is possible to cause an electronic apparatus that executes processing corresponding to a direction of a move operation to execute processing closer to the user's intention.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-220335, filed on Dec. 5, 2019, which is hereby incorporated by reference herein in its entirety.

What is claimed is:

1. An electronic apparatus comprising:
at least one processor and/or at least one circuit to perform the operations of the following units:
an operation-detecting unit configured to detect a move operation;
a notification unit configured to send a notification prompting a user to perform a move operation of drawing a linear trajectory in a specific direction; and
an execution unit configured to (1) acquire reference curve information indicating information on a curve based on a trajectory of a first move operation corresponding to the notification, which has been detected by the operation-detecting unit, wherein the reference curve information is information for determining whether the move operation is in the specific direction, and (2) execute processing based on a direction based on comparison between the reference curve information and a trajectory of a third move operation, in a case where the third move operation is performed later than the first move operation.

2. An electronic apparatus comprising:
at least one processor and/or at least one circuit to perform the operations of the following units:
an operation-detecting unit configured to detect a move operation;
a notification unit configured to send (1) a first notification prompting a user to perform a move operation of drawing a linear trajectory in a first direction and (2) a second notification prompting the user to perform a move operation of drawing a linear trajectory in a second direction vertical to the first direction; and
an execution unit configured to (1) acquire reference coordinate axis information including, in a case where a trajectory of a first move operation corresponding to the first notification and a trajectory of a second move operation corresponding to the second notification, which have been detected by the operation-detecting unit, are not in a vertical relationship, a first axis based on the trajectory of the first move operation and the second axis based on the trajectory of the second move operation, with the first and second axes being not vertical to each other, wherein the reference coordinate axis information is information for determining the direction of the move operation, and (2) execute, in a case where a third move operation is performed later than the first and second move operations, processing based on a direction based on comparison between the reference coordinate axis information and a trajectory of the third move operation detected by the operation-detecting unit.

3. The electronic apparatus according to claim 1,
wherein, in a case where a move operation in a direction parallel to the specific direction is implemented, the execution unit is further configured:
(1) to execute processing based on the specific direction in a case where the first move operation is not a curve, and
(2) not to execute processing based on the specific direction in a case where the first move operation is a curve.

4. The electronic apparatus according to claim 2,
wherein, in a case where the first move operation is a trajectory inclined at a specific angle with respect to the first axis and the second move operation is a trajectory inclined at an angle different from the specific angle with respect to the second axis, the execution unit is further configured:
(1) to execute processing based on the direction inclined at the specific angle with respect to the first axis in a case where a third move operation of drawing a trajectory inclined at the specific angle with respect to the first axis is performed later than the first and second move operations, and
(2) not execute processing based on the direction inclined at the specific angle with respect to the second axis in a case where a third move operation of drawing a trajectory inclined at the specific angle with respect to the second axis is performed later than the first and second move operations.

5. The electronic apparatus according to claim 1, wherein the move operation is an operation of moving an operating body.

6. The electronic apparatus according to claim 5, wherein the move operation is an operation of moving a touch position with respect to a touch operating member.

7. The electronic apparatus according to claim 5, wherein the move operation is an operation of moving a mouse.

8. The electronic apparatus according to claim 1, wherein the execution unit is further configured to use, from among a plurality of pieces of information, information in which a character value of a finger of a user who has performed the corresponding first move operation matches a character value of a finger of a user who performs the third move operation, as the information to be compared with the trajectory of the third move operation.

9. The electronic apparatus according to claim 1,
wherein the first move operation is a move operation performed in a calibration mode, and
wherein the third move operation is a move operation performed in a mode different from the calibration mode.

10. The electronic apparatus according to claim 1, wherein the execution unit is further configured to execute processing based on (1) the direction of the third move operation determined by performing conversion based on the comparison from the trajectory of the third move operation and (2) a movement amount of the third move operation determined without performing the conversion.

11. A control method for an electronic apparatus, the control method comprising:
detecting a move operation;
sending a notification prompting a user to perform a move operation of drawing a linear trajectory in a specific direction;
acquiring reference curve information indicating information on a curve based on a trajectory of a first move operation corresponding to the notification, which has been detected by the detecting, wherein the reference curve information is information for determining whether the move operation is in the specific direction; and
executing processing based on a direction based on comparison between the reference curve information and a trajectory of a third move operation, in a case where the third move operation is performed later than the first move operation.

12. A control method for an electronic apparatus, the control method comprising:
detecting a move operation;
sending (1) a first notification prompting a user to perform a move operation of drawing a linear trajectory in a first direction and (2) a second notification prompting the user to perform a move operation of drawing a linear trajectory in a second direction vertical to the first direction;
acquiring reference coordinate axis information including, in a case where a trajectory of a first move operation corresponding to the first notification and a trajectory of a second move operation corresponding to the second notification, which have been detected by the detecting, are not in a vertical relationship, a first axis based on the trajectory of the first move operation and the second axis based on the trajectory of the second move operation, with the first and second axes being not vertical to each other, wherein the reference coordinate axis information is information for determining the direction of the move operation; and
executing, in a case where a third move operation is performed later than the first and second move operations, processing based on a direction based on comparison between the reference coordinate axis information and a trajectory of the third move operation detected by the operation-detecting unit.

13. A non-transitory computer-readable storage medium storing a program for causing a computer to execute the control method according to claim 11.

14. A non-transitory computer-readable storage medium storing a program for causing a computer to execute the control method according to claim 12.
